(19) United States
(12) Patent Application Publication
(10) Pub. No.: US 2026/0040378 A1
(43) Pub. Date: Feb. 5, 2026

(54) POLICY BASED MULTI-LINK OPERATION ACCESS FOR DEVICES

(71) Applicant: Cisco Technology, Inc., San Jose, CA (US)

(72) Inventors: Sachin Dinkar Wakudkar, St-Sulpice (CH); Ugo Mario Campiglio, Morges (CH)

(21) Appl. No.: 18/789,056

(22) Filed: Jul. 30, 2024

(51) Int. Cl. H04W 76/15; H04W 12/06

(52) U.S. Cl. CPC H04W 76/15; H04W 12/06

(57) ABSTRACT

Methods to restrict the number of multi-link operation (MLO) links while Layer 3 (web) authentication is in progress and permit additional links only after the web authentication is completed. The methods involve obtaining an MLO policy for establishing a multi-link connection to a wireless network and performing an MLO association for establishing the multi-link connection to the wireless network based on the MLO policy in which the MLO association is restricted to a single link during a web authentication for access to the wireless network.

### TECHNICAL FIELD

The present disclosure generally relates to various communication technologies.

### BACKGROUND

Enterprises and users nowadays expect to have network connectivity nearly at all times. Public networks are readily available in public places including hotels, stores, restaurants, airports, train stations, etc. To connect a user device to a public network using a wireless network, for example, a captive portal is provided that governs access to the network. The captive portal often asks the user to accept some terms and/or conditions before access to the network is granted. Sometimes, the captive portal may ask for a payment for use of the network and at times, a username and a password may be input. In other words, users perform layer 3 (L3) authentication to gain access to a network to use that network's connectivity to engage in personal or business activities. For example, a user may connect to a wireless local area network (WLAN), such as a Wi-Fi® WLAN, to authenticate onto an enterprise network via the captive portal.

### BRIEF DESCRIPTION OF THE DRAWINGS

FIG. 1 is a block diagram illustrating a system in which a multi-link operation (MLO) association is restricted to a single link during web authentication, according to an example embodiment.

FIG. 2 is a sequence diagram illustrating a method of onboarding a guest client using MLO in which a single link is established during web authentication, according to an example embodiment.

FIG. 3 is a view illustrating a multi-link device (MLD) capability field that includes an MLO authorization indicator, according to example embodiments.

FIG. 4 is a flowchart illustrating a method of performing MLO association for establishing a multi-link connection to the wireless network in which the MLO association is restricted during web authentication, according to an example embodiment.

FIG. 5 is a hardware block diagram of a computing device that may perform functions associated with any combination of operations in connection with the techniques depicted and described in FIGS. 1-4, according to various example embodiments.

### DETAILED DESCRIPTION

### Overview

Techniques presented herein restrict the number of multi-link operation (MLO) links that may be established with a client station while Layer 3 (web) authentication is in progress and permit additional MLO links only after the web authentication is completed.

In one form, the method involves obtaining a multi-link operation (MLO) policy for establishing a multi-link connection to a wireless network and performing an MLO association for establishing the multi-link connection to the wireless network based on the MLO policy in which the MLO association is restricted to a single link during a web authentication for access to the wireless network.

### EXAMPLE EMBODIMENTS

To continuously maintain network connectivity for user devices, a multi-link operation (MLO) capability is introduced. Some wireless technologies such as Wi-Fi 7 (Institute of Electrical and Electronics Engineers (IEEE 802.11be standard) and Wi-Fi 8 (IEEE 802.11bn standard), allow a user device/a client station (referred to as “STA” or a “client STA”, interchangeably) to connect to an access point (AP) over multiple radios and/or frequency bands at substantially same time. In other words, multiple links are established between the STA and the AP for handling data traffic. The STA that supports MLO is called a non-AP multi-link device (MLD) or a client MLD. The AP that supports MLO is called an AP MLD. While example embodiments describe wireless technology with respect to the 802.11be standards, the disclosure is not limited thereto. One or more example embodiments may be applicable to other wireless technologies e.g., a wireless local area network.

The MLO capability may provide the client MLD with less traffic latency and higher data rates. However, the MLO capability may pose some challenges for the AP MLD. The MLO capability of the AP may be abused by a malicious client MLD by establishing multiple links that are not used or by perpetrating a denial of service (DOS) attack. For example, guest users or clients typically complete a Layer 3 (L3) authentication or web authentication (e.g., using a web browser) before access to the network is granted and they can send traffic. If a client MLD establishes several links at association to an AP MLD, the client MLD will not likely be using them before the L3 authentication is completed. Establishing several links before this phase means allocating resources of an access point (AP) to unutilized links. Moreover, some client MLDs may stay in a web authentication pending state for a long time. Further, a malicious client MLD could potentially perpetrate the DOS attack by allocating many links as a guest client and never completing the authentication, thus abusing AP MLD resources.

The techniques presented herein restrict the client MLD to only one link initially while web authentication i.e., L3 authentication, is performed. Until the web authentication is complete e.g., via a captive portal, the client MLD is restricted to an onboarding MLO link only and no additional MLO links may be established. The techniques presented herein further dynamically adjust the number of additional links that a client MLD may setup with the AP MLD after completing the web authentication via an MLO policy.

While one or more example embodiments are described with reference to a web authentication (e.g., using a web browser) or L3 authentication, one of ordinary skill in the art would readily appreciate that example embodiments are applicable to other use case scenarios in which authentication is performed for access to a network that are now known or hereinafter developed.

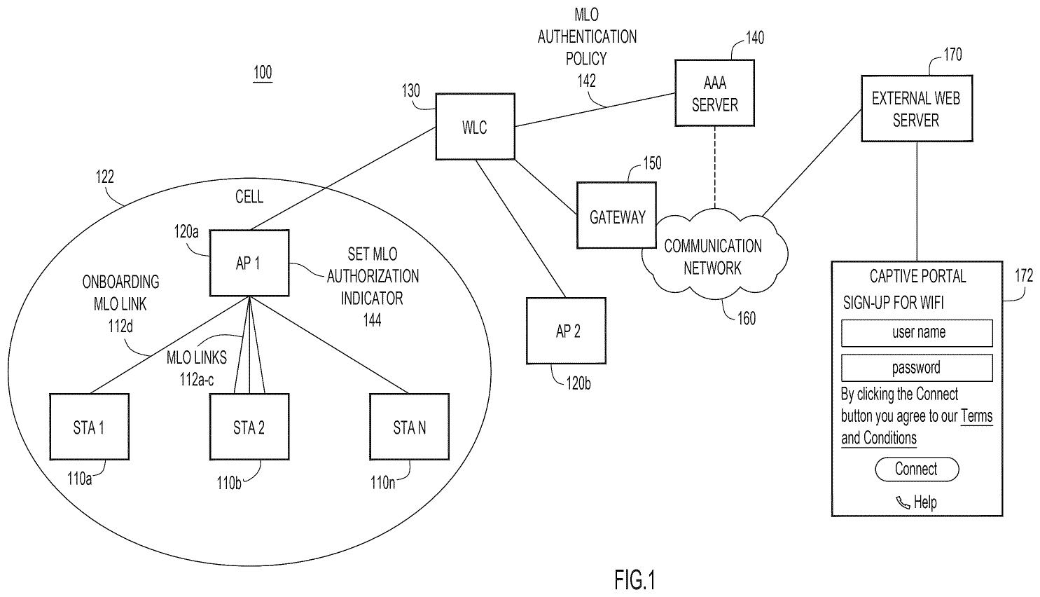

FIG. 1 is a block diagram illustrating a system 100 in which an MLO association is restricted to a single link during web authentication, according to an example embodiment. The system 100 includes client stations (the STAs 110a-n), access points such as a first AP 120a and a second AP 120b, a wireless LAN controller (WLC 130), an authentication, authorization, and accounting (AAA) server (referred to as an AAA server 140) that stores an MLO authentication policy 142, a gateway 150, a communication network 160, an external web server 170 that provides a captive portal 172 for the L3 authentication.

The notations 1, 2, 3, . . . n; a, b, c, . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

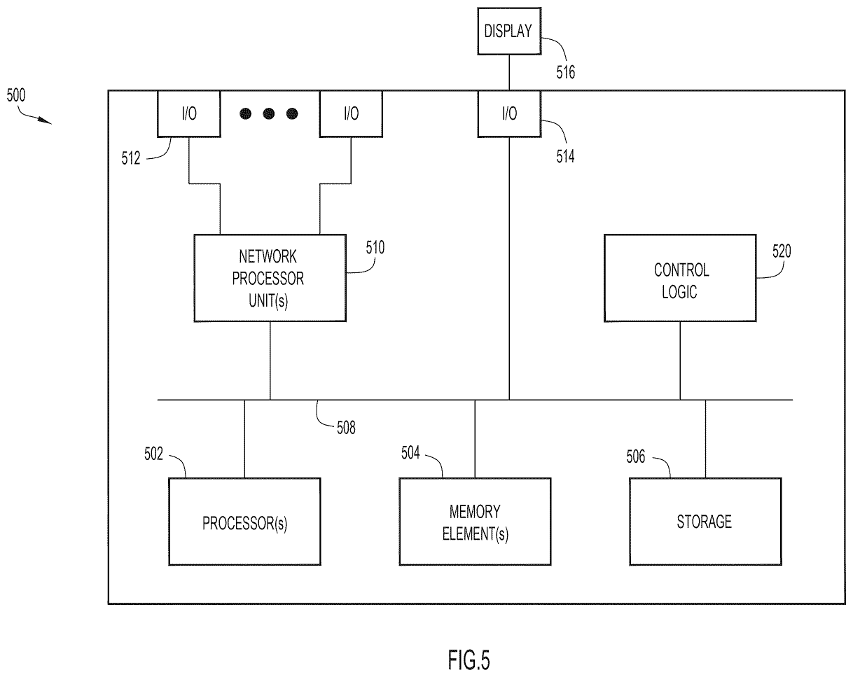

Entities of the system 100 such as the STAs 110a-n, the first AP 120a, the second AP 120b, the WLC 130, the AAA server 140, the gateway 150, and the external web server 170 may each include a network interface, at least one processor, and a memory. The network interface may include one or more network interface cards (having one or more ports) that enable components of the entity to send and receive packets or data over network(s) such as a local area network (LAN) or a wide area network (WAN), and/or wireless access networks. Each entity of the system 100 may be an apparatus or any programmable electronic or computing device capable of executing computer readable program instructions. An entity of the system 100 may include several apparatuses. The entity of the system 100 may include internal and external hardware components such as those depicted and described in further detail in FIG. 5.

The STAs 110a-n are endpoint devices or user equipment such as a smartphone, a notepad, a notebook, a personal computer, etc. In one example embodiment, an STA may be a bring your own device (BYOD) that is used to connect a user to an enterprise network after performing L3 authentication via the captive portal 172. For example, the BYOD performs web authentication by displaying, via a web browser, content received from a captive portal and obtains input from the user (i.e., user credentials) that is authenticated by an authentication server to grant access to the wireless network. Moreover, during the web authentication, check to detect a completion of a remediation with the captive portal and while remediating with the captive portal, the BYOD is permitted to establish only a single link with the wireless network.

In the system 100, the STAs 110a-n include a first STA 110a, a second STA 110b, and a third STA 110n. In one example embodiment, the STAs 110a-n are client MLDs or non AP MLDs, which may establish multiple links with the first AP 120a and/or the second AP 120b. For example, in the system 100, the first STA 110a, the second STA 110b, and the third STA 110n are associated with the first AP 120a within a cell 122. The STAs 110a-n associated with an AP MLD (the first AP 120a) within the cell 122 may be referred to as a basic service set (BSS). In the system 100, the second STA 110b established three MLO links 112a-c with the first AP 120a.

The AP MLD may communicate with one or more of the STAs 110a-n using communication links such as a downlink or forward link for communication from the AP MLD to a respective STA and uplink or reverse link for communication from the respective STA to the AP MLD. Any number of links may be established between a non AP MLD and an AP MLD and various frequency bands (e.g., 2.4 GHz, 5 GHZ, 6 GHZ) may be used depending on a particular use case scenario. In one example embodiment, the MLO authentication policy 142 defines the maximum number of simultaneous links that may be established for a respective STA e.g., based on a user subscription/profile, etc.

The first AP 120a and the second AP 120b are AP MLDs. An AP MLD may be a fixed station that communicates with the STAs 110a-n. For example, the AP MLD may be a base station or a wireless device such as a Wi-Fi router, a gateway, a hotspot, a network access point, etc. The AP MLD may perform MLO link management and dynamically establish and tear down links with one or more of the STAs 110a-n. The first AP 120a and the second AP 120b, each may generate an MLO authorization indicator that indicates whether web authorization is to be completed prior to establishing additional links, add the MLO authorization indicator to a guest basic service set identifier and provide it in a beacon, probe response, association response, and/or a reassociation response.

In one example embodiment, an AP MLD may be an authenticator that obtains the MLO authentication policy 142 from the AAA server 140, installs the MLO authentication policy 142 locally, and based on the MLO authentication policy 142 restricts the STAs 110a-n to only a single MLO link (an onboarding MLO link 112d) while web authentication is being performed. For example, in the system 100, the first STA 110a is restricted to the onboarding MLO link 112d while web authentication is being performed by the first STA 110a.

In one or more example embodiments, the AP MLD may restrict a respective STA to a single link based on the MLO authentication policy 142, which defines whether an MLO authorization indicator 144 (e.g., a flag) is to be set. When the MLO authorization indicator 144 is set, the AP MLD restricts a respective client STA to only the onboarding MLO link 112d while web authentication is being performed and no additional MLO links may be setup until the web authentication is successfully completed. For example, the MLO authorization indicator is set to 1 and is added to a guest basic service set identifier, which is then provided in a beacon, a probe response, an association response, and/or a reassociation response. In one example embodiment, when the web authentication is successfully completed (access granted), an action frame may be generated and provided that defines the number of additional links that may be setup.

In the system 100, the first AP 120a advertises to the first STA 110a that MLO authorization is required to establish multiple simultaneous links (MLO links). For example, the first AP 120a sets the MLO authorization indicator 144 (e.g., set an MLO authorization flag to a value of “1”) in a guest BSSID. This is just one example and the disclosure is not limited thereto. In one or more example embodiments, the first AP 120a may advertise that the web authentication is to be successfully completed prior to establishing multiple links through an MLO capability flags field (i.e., the MLO authorization indicator 144) in beacons, probe responses, association responses, and/or reassociation responses.

The first AP 120a and the second AP 120b are controlled by the WLC 130. That is, the WLC 130 is configured to manage and control the network e.g., the Wi-Fi network. One example of the WLC 130 is a Wi-Fi controller. The WLC 130 may configure rules such that a particular AP is favored for a particular type or class of traffic or based on quality of service (QoS) requirements, a different AP may be used. Additionally, the WLC 130 may reconfigure the first AP 120a and the second AP 120b (e.g., add a security protocol, etc.). The WLC 130 also controls the first AP 120a and the second AP 120b to setup multiple links (MLO links) with one or more of the STAs 110a-n. The WLC 130 may control the first AP 120a and the second AP 120b to add the MLO authorization indicator to a beacon, a probe response, an association response, and/or a reassociation response.

In one example embodiment, the WLC 130 may request the MLO authentication policy 142 from the AAA server 140. In yet another example embodiment, the MLO authentication policy 142 may be pushed onto the WLC 130 from the AAA server 140. The MLO authentication policy 142 may be configured or installed locally at the WLC 130 and propagated by the WLC 130 to each of the first AP 120a and the second AP 120b. For example, based on an access-accept message from the AAA server 140 (access granted) during the web authentication, the MLO authentication policy 142 is installed on the WLC 130 for the guest client. The MLO authentication policy 142 is extended with an MLO specific parameter indicating if a client STA is authorized to use MLO multi-links and how many links may be established (e.g., two links, four links, etc.).

While only the MLO authentication policy 142 is described in the system 100, the disclosure is not limited thereto. The AAA server 140 may store multiple MLO authentication policies for various user types. The WLC 130 may then be tasked with determining which policy to apply to which class of users. That is, the MLO authentication policy 142 may be associated to a subscription or a user classification such as a VIP guest or a frequent user.

For example, based on the user classification (e.g., frequent user), the STA obtains MLO capability by default. As another example, a first MLO authentication policy may be associated with a paid user type and may define four MLO links for users that pay for access to the Wi-Fi network. In the first MLO authentication policy, the MLO authorization indicator 144 is not set (e.g., the value is “0”). A second MLO authentication policy may be associated with frequent users and may define two MLO links for the frequent users. In the second MLO authentication policy, the MLO authorization indicator 144 may be set (e.g., set to a value of “1”). That is, some MLO authentication policies may restrict the STAs 110a-n to only the onboarding MLO link while web authentication is being performed, whereas other MLO authentication policies may permit the MLO multiple links to be established during web authentication.

In one example embodiment, the MLO authentication policies may be pushed to the WLC 130 based on network conditions e.g., resources in use, available resources, quality of service, number of STAs, etc. As another example, if the WLC 130 or the first AP 120a detects that the first AP 120a has only 20% of the available resources remaining, it may set the MLO authorization indicator 144 so that the first AP 120a restricts access of newly joining STAs to a single MLO link until the web authentication is successfully completed. In other words, the MLO authorization indicator 144 may be set based on network conditions and/or attributes of a respective AP.

In the system 100, the WLC 130 may control the first AP 120a to set the MLO authorization indicator 144 such that only the onboarding MLO link 112d is permitted for the first STA 110a while the L3 security authentication is being performed i.e., until the L3 authentication is successfully completed. In one example embodiment, the WLC 130 is an authenticator (optionally together with the first AP 120a or the second AP 120b). Additionally, the WLC 130 may be configured to manage a connection of the first AP 120a and the second AP 120b to the gateway 150 for external communication via the communication network 160 e.g., the Internet. Additionally, the authenticator may be configured to determine which MLO policy to apply to a particular STA based on subscriber profile and/or user information (user credentials) e.g., content related to authentication input during the remediation with the captive portal.

The AAA server 140 is configured to manage user access to the wireless network of an enterprise e.g., the Wi-Fi access. The AAA server 140 authenticates the STAs 110a-n. For example, the AAA server 140 may be a remote authentication dial-in user service (RADIUS) server that verifies user's credentials e.g., username and password. That is, the AAA server 140 stores user profiles, credentials, etc. (e.g., username, password, and related enterprise network(s) and/or wireless access network(s)). The AAA server 140 may govern time and the type of connection that is to be established e.g., the duration of the connection, the type of protocol, quality of service (QoS), etc. The AAA server 140 may further perform accounting for the established connection (a communication session) and manage billing. The AAA server 140 may further perform network monitoring to ensure the QoS is met.

In one or more example embodiments, the AAA server 140 stores the MLO authentication policy 142 (or MLO policies) and may push the MLO authentication policy 142 to the WLC 130, the first AP 120a, and/or the second AP 120b (i.e., collectively, or individually referred to as an “authenticator”). The MLO authentication policies may be dynamically programmed and pushed onto the authenticator for deployment, for example, when a new MLO authentication policy is generated and/or when an update occurs in one of the MLO authentication policies. In one example embodiment, the MLO authentication policy may be pushed onto the authenticator based on the network conditions e.g., number of associated client stations, etc. The MLO authentication policies may create different service classes for guest clients (e.g., some clients are permitted to establish more links than others). The MLO authentication policies may include the number of allowed links and whether to set the MLO authorization indicator 144, which may vary depending on different service classes.

While the AAA server 140 is depicted as connected to the WLC 130 via a local network e.g., WLAN or Wi-Fi, the disclosure is not limited thereto. In another example embodiment, the AAA server 140 may be connected to the WLC 130 via the communication network 160, depicted with a dotted line. That is, the AAA server 140 may be external to the WLAN network controlled by the WLC 130.

The gateway 150 is a network device that provides access to the communication network 160. The gateway 150 may be a router. The gateway 150 may include a dynamic host configuration protocol (DHCP) server and a domain name service (DNS) server that translates domain names to Internet Protocol (IP) addresses e.g., of the external web server 170. The gateway 150 establishes a connection to the communication network 160 for the STAs 110a-n via the first AP 120a and/or the second AP 120b.

The communication network 160 may be any number of any type of communications network (e.g., WAN, Internet, etc.).

The external web server 170 is configured to generate the captive portal 172 i.e., a captive portal remediation page, for authenticating the user of a respective STA. Content from the captive portal 172 is displayed via a web browser on a client stations. Captive portals are encountered frequently in various network environments. A respective access point and/or the WLC 130 (the authenticator) may actively block most Internet bound traffic while allowing some of the traffic to go through i.e., traffic in the direction of the captive portal until the authentication succeeds. Some captive portals may involve a payment feature or a redirection to additional one or more Internet locations. Some captive portals may involve obtaining input of user credentials (e.g., username and password) and/or users accepting some terms or conditions. An authenticator may check to detect completion of the remediation in response to a message from the AAA server 140.

The process of connecting to a network (public network, enterprise network, Internet, etc.) via the captive portal 172 is called remediation. By remediating with the captive portal 172, the user gains network connectivity to send and/or receive traffic. Typically, a web browser is used to remediate the captive portal 172 i.e., to perform web authentication or L3 security authentication. Remediating the captive portal 172 may involve displaying, via a web browser of a respective STA, content received from the captive portal 172 and obtaining user input related to authenticating a user associated with the wireless client device onto the wireless network via the captive portal 172. For example, the user may input its credentials and the respective STA may provide its credentials at a captive portal remediation page and the AAA server 140 validates these input credentials. Based on validation at the AAA server 140, the captive portal 172 may provide a response indicating that access to the wireless network of the captive portal 172 is granted or that further input to gain access to the wireless network via the captive portal 172 is to be provided.

In one example embodiment, the AAA server 140 notifies (in different ways depending on the type of web-authentication) the authenticator that the credentials were validated. As such, the authenticator determines when the remediation is finished (complete) i.e., detects a completion of a remediation with the captive portal 172 based on a notification from the AAA server 140. While remediating with the captive portal 172, the STA is permitted to establish only the onboarding MLO link (a single link).

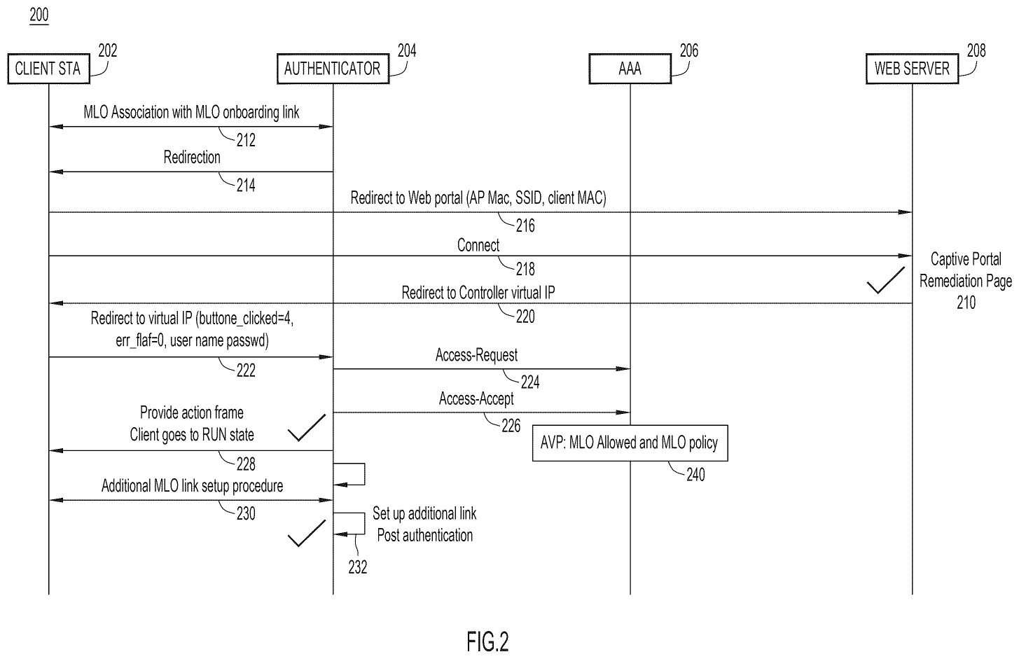

With continued reference to FIG. 1, FIG. 2 is a sequence diagram illustrating a method 200 of onboarding a guest client using MLO in which a single link is established during web authentication, according to an example embodiment.

The method 200 involves a client station 202 (client STA) such as one of the STAs 110a-n of FIG. 1, an authenticator 204 such as the first AP 120a, the second AP 120b, and/or the WLC 130 of FIG. 1, an AAA server 206 such as the AAA server 140 of FIG. 1, and a web server 208 such as the external web server 170 of FIG. 1. These are just some non-limiting examples of the entities that may be involved in the method 200. In the method 200, the AAA server 206 and a DHCP and DNS server (not shown) are external to the authenticator 204 i.e., connected with a public network such as the Internet. The DNS server (such as the gateway 150 of FIG. 1) resolves the domain name to an IP address of the web server 208.

The method 200 involves onboarding a guest client using MLO. Typically, a guest client goes through a captive portal onboarding and until the guest client authenticates through the captive portal, the guest client has no full access to the wireless network. In the method 200, the guest client can initially create only a single MLO link, called the onboarding MLO link.

Specifically, the method 200 involves at 212, the authenticator 204 (e.g., the AP MLD) advertising that MLO authorization is required to use multiple links in a guest basic service set identifier (BSSID). The advertisement may be accomplished through MLO capability flags field such as the MLO authorization indicator 144 of FIG. 1. The authenticator 204 may generate the MLO authorization indicator that indicates that the web authentication is to be performed prior to establishing additional links. The authenticator 204 adds the MLO authorization indicator to a guest BSSID or some other BSSID and advertises it in beacons, probe responses, association responses, and/or reassociation responses. When the MLO authorization indicator 144 is set, the client station 202 is restricted to the onboarding MLO link prior to successfully authenticating with the web server 208 via the captive portal. As such, the client station 202 (the non-AP MLD) associates to the MLO BSSID i.e., the authenticator 204, via the MLO onboarding link.

The method 200 further involves at 214, the authenticator 204 redirecting the client station 202 to a captive portal provided by the web server 208 to perform L3 authentication.

At 216, the client station 202 is redirected to the IP address of the web server 208 (i.e., a captive portal remediation page 210). The redirection message includes a media access control (MAC) address of the client station 202, a MAC address of the authenticator 204, and a service set identifier (SSID). The web server 208 provides the captive portal remediation page 210 where the user is expected to input username and password or any other form of authentication (e.g., accept service provider's conditions), at 218.

Remediating a captive portal during the web authentication may involve displaying, via a web browser of the client station 202, content received from the web server 208. The web server 208 obtains user input related to authenticating a user associated with the client station 202 onto the wireless network via the captive portal remediation page 210. A completion of the remediation with the captive portal is detected e.g., user inputs enter or clicks a button. Based on the completion of the remediation process, the web server 208 provides the input user credentials for validation to the AAA server 206.

Specifically, at 220, the web server 208 provides a virtual IP address of the authenticator 204 to the client station 202 (i.e., redirects the client station 202 to the virtual IP of the authenticator 204). At 222, the client station 202 connects to the authenticator 204 (via the virtual IP) and includes the username and password, among other parameters such as button_clicked=4, error flag=0, etc. At 224, the authenticator 204 transmits an access request message to the AAA server 206. The access request message is a request to access the wireless network based on the input user credentials. In other words, when the non-AP MLD (the client station 202) inputs credentials, the authenticator 204 forwards these credentials with an access request to the AAA server 206 for validation.

The AAA server 206 may return an access reject if credentials are not validated (i.e., further input is to be provided to obtain access to the wireless network) or an access accept if the credentials are validated. Specifically, at 226, the AAA server 206 returns, to the authenticator 204, an access accept with attribute value pair (AVP) 240 that includes that the MLO is allowed and an MLO authentication policy (number of links, etc.). In one example embodiment, the AAA server 206 determines the user type based on the user credentials and determines or selects an associated MLO authentication policy i.e., the policy that relates to the determined user type.

Based on the operation 226 (the access-accept), the MLO authentication policy is installed at the authenticator 204 for the guest client (the client station 202). The MLO policy that is applied is extended with an MLO specific parameter indicating if the client station 202 is authorized to use the MLO, how many links the client station 202 can establish. The MLO authentication policy may be configured locally on the he authenticator 204 or pushed by the AAA server 206 in the access accept e.g., with a new vendor specific radius attribute in the AVP 240.

In one example embodiment, the MLO authentication policy is associated to a subscription or user classification, for example with a VIP guest, or a frequent user may obtain MLO by default. The MLO authorization for a guest client may be value added services. While one example embodiment is for a guest client, in another example embodiment, the same technique may be applied to a non-guest BSSID that is subject to the web authentication. For example, BYOD devices are not likely entitled to use MLO in a default policy but administrators can elevate the privileges by dynamically pushing MLO authentication policies in a change of authorization (CoA).

At 228, the authenticator 204 connects the client station 202 to the wireless network e.g., WLAN. That is, the client station 202 is placed in a run state. Further, the authenticator 204 obtains, from the MLO authentication policy, the number of links that the guest client (the client station 202) is authorized to establish and communicates this information to the client station 202 i.e., in an action frame. That is, the authenticator 204 generate a new action frame that indicates that the client station 202 may start its MLO session and how many additional MLO links can be added to the primary MLO link that was initially established. The client station 202 may now add links within the assigned limit to the Guest MLO dynamically if the guest client is authorized to use more than one link in the MLO.

At 230, additional MLO link setup procedure is performed between the client station 202 and the authenticator 204 (e.g., AP MLD) and at 232, the authenticator 204 sets up additional links (post authentication).

In one or more example embodiments, the authenticator 204 is configured to perform multi-link device (MLD) capability signaling, which includes control information that activates or deactivates auxiliary/additional links based on communication load, quality of service, throughput requirements, etc. Signaling may include requests, acknowledgments, or negotiation regarding multi-link connections. Timing and signaling information may be used to coordinate when additional links are used for communication or when to promote an additional link to an anchor link. The capability signaling may include an MLD capabilities field.

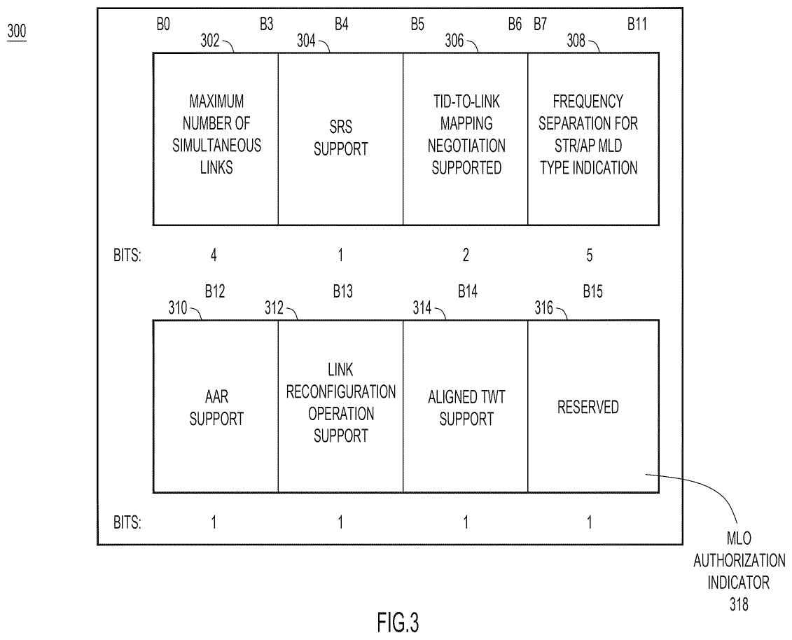

With continued reference to FIGS. 1 and 2, FIG. 3 is a view illustrating a MLD capability field 300 that includes an MLO authorization indicator, according to an example embodiment. The MLD capability field 300 is defined in “figure 9-1001k—MLD Capabilities and Operations subfield format” of a basic multi-link element in the IEEE 802.11be D5.0 standard specification.

The MLD capability field 300 includes a maximum number of simultaneous links subfield 302, an SRS support subfield 304, TID-to-link mapping negotiation supported subfield 306, a frequency separation for STR subfield 308, an AAR support subfield 310, a link reconfiguration operation support 312, an aligned TWT support 314, and a reserved field 316. The reserved field 316 includes an MLO authorization indicator 318. In one example embodiment, the reserved field 316 is just one bit. Yet in another example embodiment, the reserved field 316 may include multiple bits where one bit would be the MLO authorization indicator 318.

These are just some examples of various subfields that may be configured to include the MLO authorization indicator 318 but the disclosure is not limited thereto. In one example embodiment, the MLO authorization indicator 318 may be provided in a separate field or a new information element. For example, a new information element (IE) may include additional information related to MLO capability such as the number of additional links permitted, class of users, etc. In one example embodiment, the MLO authorization indicator 318 may be provided in another subfield.

The table below provides exemplary definitions for these subfields as defined in the WPA 802.11be standard.

| Subfield | Definition | Encoding |
|---|---|---|
| Maximum number of | Indicates the maximum | Set to a value between 0 and 14, |
| simultaneous links subfield | number of STAs affiliated | which is the maximum number of |
| 302 | with the MLD that support | affiliated STAs of the MLD that |
| | simultaneous transmission | support simultaneous transmission |
| | or reception of frames on | or reception of frames minus 1. |
| | the respective links | |
| SRS support subfield | Indicates support for the | For an AP MLD: |
| 304 | reception of a frame that | Set to 1 to indicate that the AP |
| | carries an SRS Control | MLD, with which the AP is |
| | sub- field. | affiliated, is capable of receiving |
| | | frames with an SRS control |
| | | subfield. Set to 0 otherwise. |
| | | For a non-AP MLD: |
| | | Set to 1 to indicate that a non-AP |
| | | MLD with which the non-AP STA |
| | | is affiliated, is capable of receiving |
| | | frames with an SRS control |
| | | subfield. |
| | | Set to 0 otherwise. |
| TID-to-link mapping | Indicates support for traffic | Set to 0 if |
| negotiation supported | identifier (TID)-to-link | dot11TIDtoLinkMappingActivated |
| subfield | mapping negotiation | is false and TTLM negotiation is |
| 306 | | not supported by the MLD. |
| | | Set to 1 if dot11TIDto |
| | | LinkMappingActivated is true and |
| | | the MLD only supports the |
| | | mapping of all TIDs to the same |
| | | link set, both for downlink and |
| | | uplink. |
| | | The value 2 is reserved. |
| | | Set to 3 if dot11TIDto |
| | | LinkMappingActivated is true and |
| | | the MLD supports the mapping of |
| | | each TID to the same or different |
| | | link set. |
| Frequency separation for | When transmitted by a | For a non-AP MLD: |
| STR subfield | non-AP STA affiliated | When set to a nonzero value n, the |
| 308 | with a non-AP MLD, the | Frequency Separation for STR |
| | subfield is the Frequency | subfield indicates that the STR |
| | Separation for STR | frequency gap is (n-1) X 80 MHz. |
| | subfield and it indicates the | The value 0 indicates no frequency |
| | minimum frequency gap | separation information is provided. |
| | between any two links that | AP MLD Type Indication: |
| | is recommended by the | For an AP MLD: |
| | non-AP MLD for STR | Set B0 of the AP MLD Type |
| | operation. The frequency | Indication subfield to 1 to indicate |
| | gap is specified as the | that the AP MLD is an NSTR |
| | difference between the | mobile AP MLD. |
| | nearest frequency edges of | Set to 0 otherwise. |
| | the two links. | B1-B4 of the AP MLD Type |
| | When transmitted by an | Indication subfield are reserved. |
| | AP affiliated with an AP | |
| | MLD, the sub-field is the | |
| | AP MLD Type Indication | |
| | subfield and it indicates the | |
| | type of an AP MLD. | |
| AAR support subfield | An AP MLD indicates | If the +HTC-HE Support subfield |
| 310 | support for receiving a | is 1: |
| | frame with an AAR control | Set to 1 if the AP MLD supports |
| | subfield | the AAR control subfield |
| | | functionality. |
| | | Set to 0 otherwise. |
| | | Reserved for non-AP MLD or if |
| | | the +HTC-HE support subfield is |
| | | 0. |
| Link reconfiguration | Indicates support for ML | Set to 1 if |
| operation support | reconfiguration operations | dot11EHTLLinkReconfiguration |
| 312 | for adding a link and | Operation Activated equal to true |
| | deleting a link to the ML | Set to 0 otherwise. |
| | setup of a non-AP MLD | |
| | and support for | |
| | reconfiguration for ML | |
| | reconfiguration to the ML | |
| | setup of a non-AP MLD | |
| Aligned TWT support | Indicates support for an | For an MLD: |
| 314 | alignment or nonalignment | Set to 1 to indicate that an MLD |
| | of the TWT's across more | with which the STA is affiliated is |
| | than one link | capable of receiving a TWT setup |
| | | frame that requests an alignment |
| | | or nonalignment of the TWTs |
| | | across more than one link. |
| | | Set to 0 otherwise. |

The reserved field 316 includes the MLO authorization indicator 318. The MLO authorization indicator 318 may be an MLO authorization flag such as adding a one bit capability flag as MLO authorization required flag with which the AP MLD indicates if the non-AP MLD is permitted to establish additional links prior notification (action frame) after the web authentication. In one example embodiment, the reserved field 316 may further include the number of simultaneous links that may be established by the subscriber or user of the STA.

The techniques presented herein provide a method through which MLO resources are allowed to guest clients (and non-guest web authenticated clients) only after authentication and based on the applied MLO policy. The techniques presented herein allow multilink MLO as an added value service over a single MLO link. MLO links for guest clients may be authorized from an authentication server through a policy push to avoid resources being held by a station that is not completing the L3 security authentication or rogue station(s). The MLO policy defines the number of links a non-AP MLD may establish. Before the policy is installed, a single link is established by the non-AP MLD. The non-AP MLD is informed through an action frame of the additional links that may be established after completing successful web authentication. Prior to successfully completing the web authentication, the non-AP MLD is restricted to a single link. The techniques presented herein further allow for creating different service classes for guest clients (some clients can establish more links than others).

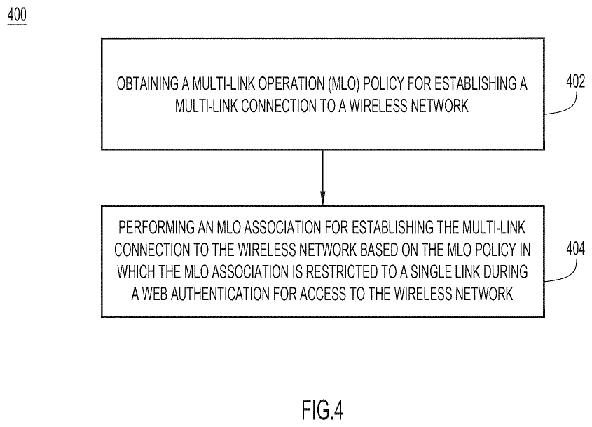

FIG. 4 is a flowchart illustrating a method 400 of performing MLO association for establishing a multi-link connection to the wireless network in which the MLO association is restricted during a web authentication, according to an example embodiment. The method 400 may be performed by one or more computing devices or an apparatus. For example, the method 400 may be performed by one of the first AP 120a, the second AP 120b, and/or the WLC 130 of FIG. 1 or the authenticator 204 of FIG. 2.

The method 400 involves at 402, obtaining a multi-link operation (MLO) policy for establishing a multi-link connection to a wireless network.

The method 400 further involves at 404, performing an MLO association for establishing the multi-link connection to the wireless network based on the MLO policy in which the MLO association is restricted to a single link during a web authentication for access to the wireless network.

In one instance, in the method 400, the single link may be an onboarding MLO link for the web authentication via a captive portal.

According to one or more example embodiments, the MLO association may be restricted to the single link during the web authentication based on an authorization indicator in the MLO policy.

In one form, the operation 404 of performing the MLO association may include establishing, by one or more of an access point multi-link device (AP MLD) or a wireless local access network controller, the single link for the web authentication by a non-AP MLD and establishing at least one additional link for the non-AP MLD after the web authentication.

According to one or more example embodiments, the method 400 may further include generating an MLO authorization indicator that indicates that the web authentication is to be completed prior to establishing at least one additional link with the wireless network for a client station and adding the MLO authorization indicator to a guest basic service set identifier.

In one instance, the method 400 may further include providing, to the client station, one or more of: a beacon, a probe response, an association response, or a reassociation response, each of which includes the MLO authorization indicator.

In another form, the method 400 may further include remediating a captive portal remediation page for a wireless client device during the web authentication.

According to one or more example embodiments, the method 400 may further include remediating a captive portal during the web authentication by displaying, via a web browser of a wireless client device, content received from the captive portal and by obtaining user input related to authenticating a user associated with the wireless client device onto the wireless network via the captive portal. Remediating the captive portal during the web authentication may further include providing the user input to the captive portal and obtaining, from the captive portal, a response indicating one of access to the wireless network of the captive portal is granted, or further input to obtain the access to the wireless network via the captive portal is to be provided. Remediating the captive portal during the web authentication may further include detecting a completion of a remediation with the captive portal. The method 400 may further include while remediating with the captive portal, establishing only the single link with the wireless network.

In another form, the operation 404 of performing the MLO association may further include establishing at least one additional link with the wireless network based on detecting the completion of the remediation with the captive portal and validating of the user input by an authentication server.

In yet another form, the method 400 may further include determining a user type based on information from a wireless client device, associating the MLO policy based on the user type, and providing, to the wireless client device, an action frame that defines a number of additional links that are to be established after completing the web authentication.

According to one or more example embodiments, the wireless network may be a wireless local access network and the web authentication may be a Layer 3 security authentication.

FIG. 5 is a hardware block diagram of a computing device 500 that may perform functions associated with any combination of operations in connection with the techniques depicted in FIGS. 1-4, according to various example embodiments, including, but not limited to, operations of one or more entities of FIGS. 1-2 such as one of the STAs 110a-n, the first AP 120a, the second AP 120b, the WLC 130, the AAA server 140, the gateway 150, or the external web server 170, of FIG. 1 or such as the client station 202, the authenticator 204, the AAA server 206, or the web server 208, of FIG. 2. It should be appreciated that FIG. 5 provides only an illustration of one example embodiment and does not imply any limitations with regard to the environments in which different example embodiments may be implemented. Many modifications to the depicted environment may be made.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with one or more memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 516, a display screen (touch screen on a mobile device), or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory and a network interface configured to enable network communications. The apparatus further includes a processor. In this apparatus, the processor is configured to perform a method, which includes obtaining a multi-link operation (MLO) policy for establishing a multi-link connection to a wireless network and performing an MLO association for establishing the multi-link connection to the wireless network based on the MLO policy in which the MLO association is restricted to a single link during a web authentication for access to the wireless network.

In yet another example embodiment, one or more non-transitory computer readable storage media encoded with instructions are provided. When the media is executed by a processor, the instructions cause the processor to execute a method that involves obtaining a multi-link operation (MLO) policy for establishing a multi-link connection to a wireless network and performing an MLO association for establishing the multi-link connection to the wireless network based on the MLO policy in which the MLO association is restricted to a single link during a web authentication for access to the wireless network.

In yet another example embodiment, a system is provided that includes the devices and operations explained above with reference to FIGS. 1-5.

The programs described herein (e.g., control logic 520) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 506 and/or memory elements(s) 504 can store data, software, code, instructions (e.g., processor instructions), logic, parameters, combinations thereof, and/or the like used for operations described herein. This includes the storage 506 and/or memory elements(s) 504 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., WiFi®/WiFi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a multi-link operation (MLO) policy for establishing a multi-link connection to a wireless network; and
performing an MLO association for establishing the multi-link connection to the wireless network based on the MLO policy in which the MLO association is restricted to a single link during a web authentication for access to the wireless network.

2. The method of claim 1, wherein the single link is an onboarding MLO link for the web authentication via a captive portal.

3. The method of claim 1, wherein the MLO association is restricted to the single link during the web authentication based on an authorization indicator in the MLO policy.

4. The method of claim 1, wherein performing the MLO association includes:
establishing, by one or more of an access point multi-link device (AP MLD) or a wireless local access network controller, the single link for the web authentication by a non-AP MLD; and
establishing at least one additional link for the non-AP MLD after the web authentication.

5. The method of claim 1, further comprising:
generating an MLO authorization indicator that indicates that the web authentication is to be completed prior to establishing at least one additional link with the wireless network for a client station; and
adding the MLO authorization indicator to a guest basic service set identifier.

6. The method of claim 5, further comprising:
providing, to the client station, one or more of: a beacon, a probe response, an association response, or a reassociation response, each of which includes the MLO authorization indicator.

7. The method of claim 1, further comprising:
remediating a captive portal remediation page for a wireless client device during the web authentication.

8. The method of claim 1, further comprising:
remediating a captive portal during the web authentication by:
displaying, via a web browser of a wireless client device, content received from the captive portal;
obtaining user input related to authenticating a user associated with the wireless client device onto the wireless network via the captive portal;
providing the user input to the captive portal;
obtaining, from the captive portal, a response indicating one of:
access to the wireless network of the captive portal is granted, or
further input to obtain the access to the wireless network via the captive portal is to be provided; and
detecting a completion of a remediation with the captive portal; and
while remediating with the captive portal, establishing only the single link with the wireless network.

9. The method of claim 8, wherein performing the MLO association includes:
establishing at least one additional link with the wireless network based on detecting the completion of the remediation with the captive portal and validating of the user input by an authentication server.

10. The method of claim 1, further comprising:
determining a user type based on information from a wireless client device;
associating the MLO policy based on the user type; and
providing, to the wireless client device, an action frame that defines a number of additional links that are to be established after completing the web authentication.

11. The method of claim 1, wherein the wireless network is a wireless local access network and the web authentication is a Layer 3 security authentication.

12. An apparatus comprising:
a memory;
a network interface configured to enable network communications; and
a processor, wherein the processor is configured to perform a method comprising:
obtaining a multi-link operation (MLO) policy for establishing a multi-link connection to a wireless network; and
performing an MLO association for establishing the multi-link connection to the wireless network based on the MLO policy in which the MLO association is restricted to a single link during a web authentication for access to the wireless network.

13. The apparatus of claim 12, wherein the single link is an onboarding MLO link for the web authentication via a captive portal.

14. The apparatus of claim 12, wherein the MLO association is restricted to the single link during the web authentication based on an authorization indicator in the MLO policy.

15. The apparatus of claim 12, wherein the apparatus is an access point multi-link device (AP MLD) or a wireless local access network controller and the processor is configured to perform the MLO association by:
establishing the single link for the web authentication by a non-AP MLD; and
establishing at least one additional link for the non-AP MLD after the web authentication.

16. The apparatus of claim 12, wherein the processor is further configured to perform:
generating an MLO authorization indicator that indicates that an MLO authorization is to be performed prior to establishing at least one additional link with the wireless network for a client station; and
adding the MLO authorization indicator to a guest basic service set identifier.

17. The apparatus of claim 16, wherein the processor is further configured to perform:
providing, to the client station, one or more of: a beacon, a probe response, an association response, or a reassociation response, each of which includes the MLO authorization indicator.

18. One or more non-transitory computer readable storage media encoded with software comprising computer executable instructions that, when executed by a processor, cause the processor to perform a method including:
obtaining a multi-link operation (MLO) policy for establishing a multi-link connection to a wireless network; and
performing an MLO association for establishing the multi-link connection to the wireless network based on the MLO policy in which the MLO association is restricted to a single link during a web authentication for access to the wireless network.

19. The one or more non-transitory computer readable storage media according to claim 18, wherein the single link is an onboarding MLO link for the web authentication via a captive portal.

20. The one or more non-transitory computer readable storage media according to claim 18, wherein the MLO association is restricted to the single link during the web authentication based on an authorization indicator in the MLO policy.
